(19) United States
(12) Patent Application Publication
(10) Pub. No.: US 2019/0369824 A1
(43) Pub. Date: Dec. 5, 2019

(54) COMPUTERIZED SYSTEM AND METHOD FOR NOTE TAKING

(71) Applicants: Thomas Alan Robinson, Saint Clair Shores, MI (US); Maxwell Scott Matthews, Grosse Pointe Woods, MI (US)

(72) Inventors: Thomas Alan Robinson, Saint Clair Shores, MI (US); Maxwell Scott Matthews, Grosse Pointe Woods, MI (US)

(21) Appl. No.: 16/425,465

(22) Filed: May 29, 2019

Related U.S. Application Data
(60) Provisional application No. 62/677,972, filed on May 30, 2018.

(51) Int. Cl. G06F 3/0484; G06F 3/0481; G06F 17/22

(52) U.S. Cl. CPC G06F 3/0484; G06F 17/2247; G06F 3/0481

(57) ABSTRACT

A computing device and computer-implemented method for creating and storing notes. The computing device can receive a user input from a user to begin execution of a first application. In response to receiving the user input, the computing device can execute the first application in a foreground of the computing device and determine if the user has associated, in a note storage application, a stored note with the first application based on the first application and the user. When the user has associated the stored note with the first application in the note storage application, the computing device can further execute the note storage application in a background of the computing device and display a user interface element in the user interface of the first application, wherein the user interface element indicates a presence of the stored note associated with the first application.

### CROSS-REFERENCE TO RELATED APPLICATION

This application claims the benefit of U.S. Provisional Application No. 62/677,972, filed on May 30, 2018. The disclosure of the above application is incorporated herein by reference in its entirety.

### FIELD

The present disclosure relates to a computerized system and method for creating and storing notes and, more particularly, to a computer program, application, website, or other computer implemented technique for the easy creation, storage, and retrieval of electronic notes.

### BACKGROUND

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

The Internet allows a user to perform for an amazing number of activities via a computer, mobile phone, etc. For example only, a user can check a bank balance, read a newspaper article, and post an update or status to a social network all in a short period of time. A user can also buy goods or services online, transfer money to others, make restaurant or event reservations, and even order food online. With all of these different tasks and information available at the click of a button, it is not surprising that a user may have trouble remembering something about the website or application that she/he is viewing. Presently, a user may make a physical note on a note pad or the like, send an email to her/himself, or even add an event in a calendar application to “take notes” about an online activity or task that she/he wishes to perform. In such cases, these notes may get lost in that the user may not remember where she/he stored such a note, or even whether a note was created. It would be desirable to provide an improved system and computer-implemented method that permits a user to easily create, store, and retrieve notes for a website or computer application.

### SUMMARY

In various embodiments of the present disclosure, an improved system and computer-implemented method that permits people to easily create, store, and retrieve notes for a website or computer application is disclosed. A system and computer-implemented method of note taking are presented. A user can be presented with a link, popup window, etc. whenever a user accesses a website or application that allows access to an electronic note for that specific website or application. In this manner, a user can make website and application specific notes that are simple to access when such notes are relevant

In some implementations, the present disclosure is directed to a computer-implemented method for creating and storing notes. The method can include receiving, at a computing device having one or more processors, a user input from a user to begin execution of a first application. In response to receiving the user input, the computing device can execute the first application in a foreground of the computing device, wherein executing the first application includes displaying a user interface of the first application. The method can also include determining, at the computing device, if the user has associated, in a note storage application, a stored note with the first application based on the first application and the user. When the user has associated the stored note with the first application in the note storage application, the computing device can further execute the note storage application in a background of the computing device and display a user interface element in the user interface of the first application, wherein the user interface element indicates a presence of the stored note associated with the first application.

In various aspects, the method can also include receiving, at the computing device, a user selection of the user interface element. In response to receiving the user selection, the computing device can retrieve and display the stored note. Displaying the stored note can comprise displaying the stored note in the user interface of the first application and/or displaying the stored note in an overlay in the user interface of the first application. The method can also include receiving, at the computing device, one or more edits to the stored note from the user and updating the stored note to include the one or more edits.

According to some implementations, the first application can be a web browser application and determining if the user has associated the stored note with the first application can be further based on a webpage being displayed by the web browser. In such implementations, the user interface element can comprise a hyperlink displayed by the web browser, a selectable button displayed by the web browser, or any other type of user interface element. The stored note can be stored locally at the computing device, stored remotely from the computing device, or a combination thereof.

In various additional embodiments of the present disclosure, a computing device that permits people to easily create, store, and retrieve notes for a website or computer application is disclosed. The computing device includes one or more processors, and a non-transitory computer-readable storage medium having a plurality of instructions stored thereon, which, when executed by the one or more processors, cause the one or more processors to perform operations. The operations can include any of the described methods herein or portion thereof.

Further areas of applicability of the present disclosure will become apparent from the detailed description provided hereinafter. It should be understood that the detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a diagram of an example computing system including an example computing device and an example server computing device according to some implementations of the present disclosure;

FIG. 2 is a functional block diagram of the example computing device of FIG. 1;

FIG. 3 is an example graphical user interface corresponding to a web browser with an associated note application according to some implementations of the present disclosure;

FIG. 4 is another example graphical user interface corresponding to a web browser with an associated note application according to some implementations of the present disclosure;

FIG. 5 is yet another example graphical user interface corresponding to a web browser with an associated note application according to some implementations of the present disclosure; and

FIG. 6 is a flow diagram of an example technique for creating, storing, and retrieving electronic notes according to some implementations of the present disclosure.

### DETAILED DESCRIPTION

As previously discussed, while the Internet allows a user to perform for an amazing number of activities online, there exists a need for an improved system and computer-implemented method that permits people to easily create, store, and retrieve notes. Accordingly, a system and computer-implemented method of note taking are presented. When accessing a website via a web browser, or when executing an application, a user can be automatically presented with a note application that can be specific to the website or application accessed. From this interface, the user can add a note, edit a previous note, and retrieve a note that can contain information relevant to the user and the website/application. Further details are included below.

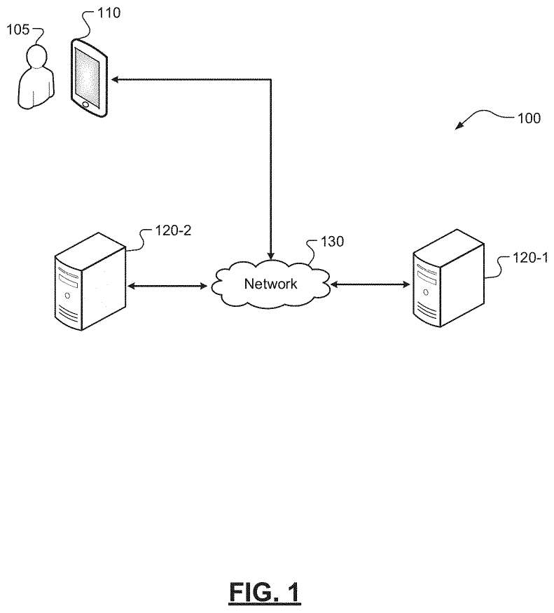

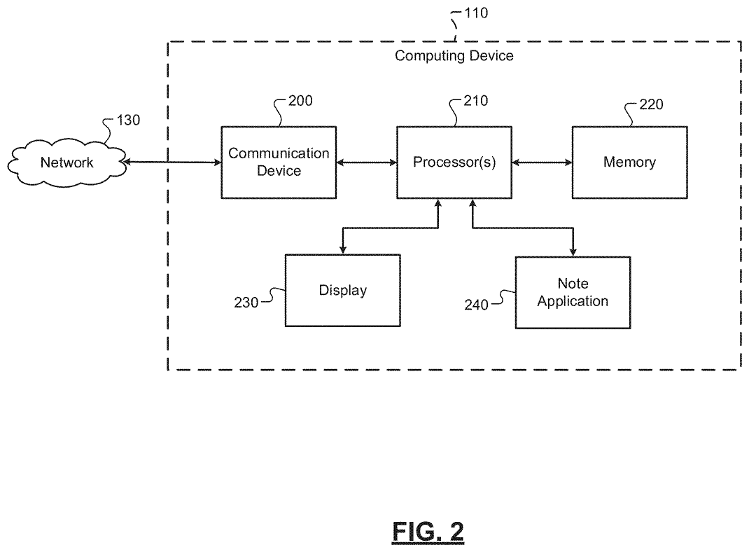

Referring now to FIG. 1, a diagram of an example computing system 100 is illustrated. The computing system 100 can be configured to implement the note application described herein amongst a plurality of users via their computing devices. The computing system 100 can include one or more example computing devices 110 and one or more example servers 120 that communicate via a network 130 according to some implementations of the present disclosure. For ease of description, in this application and as shown in FIG. 1, one example computing device 110 and two example server computing devices 120 (server computing devices 120-1 and 120-2) are illustrated and described. It should be appreciated, however, that there can be more computing devices 110 and more or less server computing devices 120 than is illustrated. While illustrated as a mobile phone (“smart” phones), each computing device 110 can be any type of suitable computing device, such as a desktop computer, a tablet computer, a laptop computer, a wearable computing device such as eyewear, a watch or other piece of jewelry, or clothing that incorporates a computing device. A functional block diagram of an example computing device 110 is illustrated in FIG. 2.

The computing device 110 can include a communication device 200, one more processors 210, a memory 220, a display device 230, and a note storage application 240 (referred to herein as “note application 240”). The processor(s) 210 can control operation of the computing device 110, including implementing at least a portion of the techniques of the present disclosure. The term “processor” as used herein is intended to refer to both a single processor and multiple processors operating together, e.g., in a parallel or distributed architecture.

The communication device 200 can be configured for communication with other devices (e.g., the server computing devices 120 or other computing devices 110) via the network 130. One non-limiting example of the communication device 200 is a transceiver, although other forms of hardware are within the scope of the present disclosure. The memory 220 can be any suitable storage medium (flash, hard disk, etc.) configured to store information. For example, the memory 220 may store a set of instructions that are executable by the processor 210, which cause the computing device 110 to perform operations, e.g., such as the operations of the present disclosure. The display device 230 can display information to the user 105. In some implementations, the display device 230 can comprise a touch-sensitive display device (such as a capacitive touchscreen and the like), although non-touch display devices are within the scope of the present disclosure.

It should be appreciated that the example server computing devices 120 can include the same or similar components as the computing device 110, and thus can be configured to perform some or all of the techniques of the present disclosure, which are described more fully below. Further, while the techniques of the present disclosure are described herein in the context of a computing device 110, it is specifically contemplated that each feature of the techniques may be performed by a computing device 110 alone, a plurality of computing devices 110 operating together, a server computing device 120 alone, a plurality of server computing devices 120 operating together, and a combination of one or more computing devices 110 and one or more server computing devices 120 operating together.

As briefly mentioned above, the note application 240 can allow a user 105 to create, store, and access notes for later reference, e.g., during browsing of a website and/or execution of an application. The note application 240 can be password protected such that only a certain user 105 may access the stored notes. The note application 240 can store the notes locally at the computing device 110 (e.g., in memory 220) and/or remotely from the computing device 110 (e.g., on a cloud based server such as server computing devices 120-1, 120-2 or an external database). In some embodiments, the user can access these notes by clicking a link on websites that subscribe to or support the note application. In other embodiments, the note application can receive information from a web browser such that accessing a website with an associated note automatically launches the note application. Similarly, upon execution of an application that has an associated note, the note application can automatically be launched in some embodiments. Various example embodiments are described more fully below.

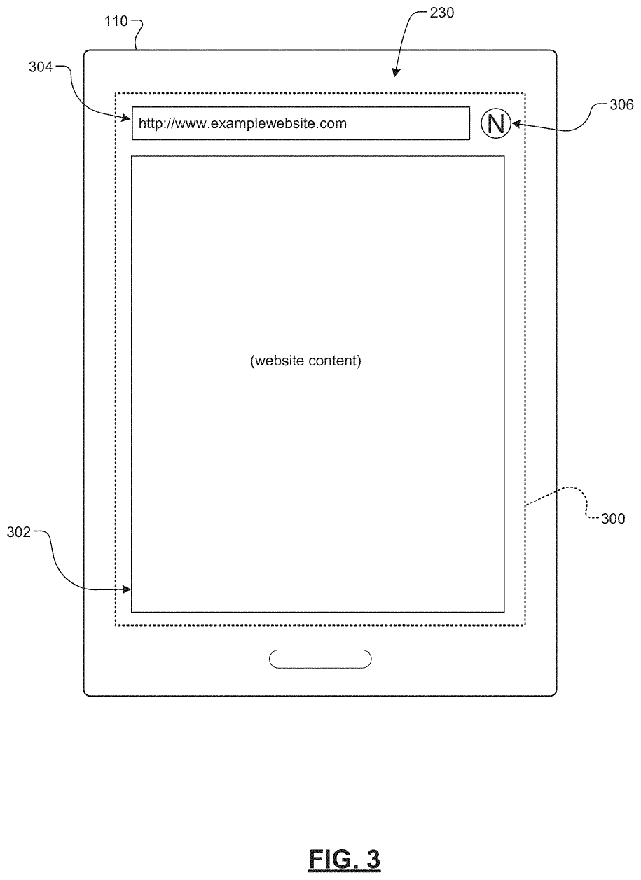

With reference to FIG. 3, an example graphical user interface 300 corresponding to a web browser 302 and a note application 240 according to some implementations of the present disclosure is shown. In this example, the web browser 302 displays website content in a main portion of the graphical user interface 300 and also includes a uniform resource locator input and display portion 304. The web browser 302 further includes a launch button 306 for the note application 240. Upon the web browser 302 retrieving the information from a website, the launch button 306 can be displayed to the user 105. In some aspects, the launch button 306 is displayed only when the note application 240 determines that the displayed website has an associated note. In other aspects, the launch button 306 is always displayed such that a user 105 can create a note with the note application 240 whether or not a note currently exists for the displayed website.

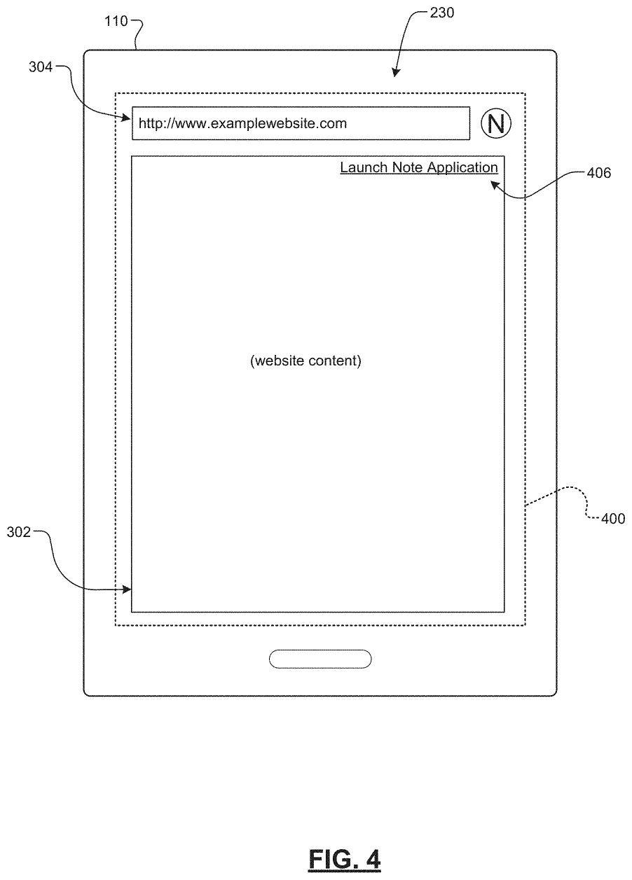

With reference to FIG. 4, another example graphical user interface 400 corresponding to a web browser 302 and a note application 240 according to some implementations of the present disclosure is shown. In this example, the web browser 302 displays a hyperlink 406 that, when selected by a user 105, launches the note application 240. Upon the web browser 302 retrieving the information from a website, the hyperlink 406 can be displayed to the user 105. In some aspects, the hyperlink 406 is displayed only when the note application 240 determines that the displayed website has an associated note. In other aspects, the hyperlink 406 is always displayed such that a user 105 can create a note with the note application 240 whether or not a note currently exists for the displayed website.

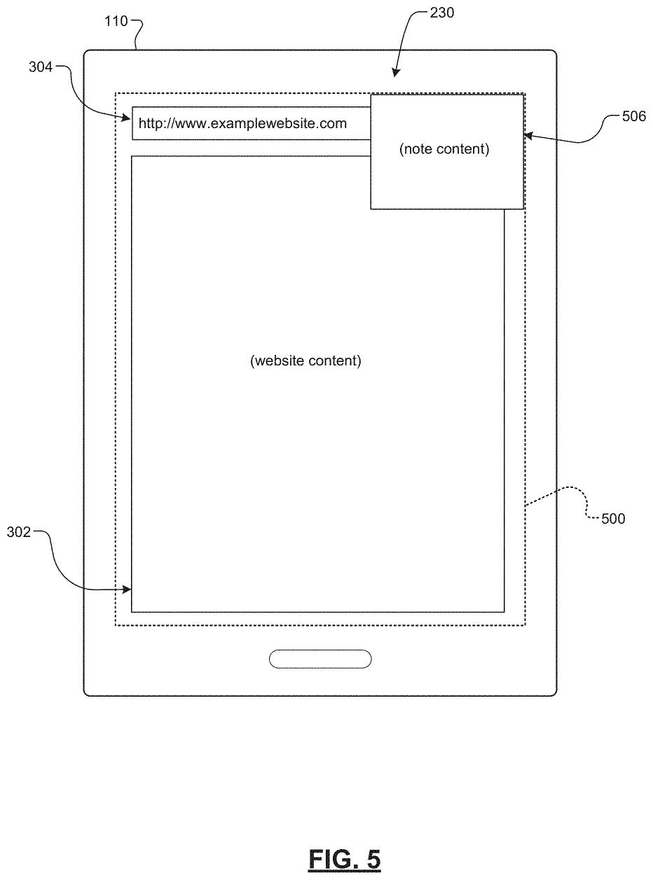

With reference to FIG. 5, another example graphical user interface 500 corresponding to a web browser 302 and a note application 240 according to some implementations of the present disclosure is shown. In this example, the web browser 302 displays a note 506 received from the note application 240. Upon the web browser 302 retrieving the information from a website, the note 506 can be displayed to the user 105. In some aspects, the note 506 is displayed only when the note application 240 determines that the displayed website has an associated note. In other aspects, the note 506 is always displayed such that a user 105 can create a note with the note application 240 whether or not a note currently exists for the displayed website.

As mentioned above, the note application 240 can store the notes 506 in various places, including memory 220 and external storage. Further, the note application 240 can be implemented in various manners. In one example, the note application 240 can be implemented by the website provider (or application provider) such that all users visiting the website or executing the application can have access to the note application 240. In these embodiments, the note application 240 may store the note related information at the server computing device 120-1 associated with the website/application provider, at the computing device 110, or a combination thereof.

In another example, the note application 240 can be implemented by the user computing device 110 such that the note application 240 is available for use with any website or application, irrespective of whether the website or application supports the note application 240. In these embodiments, the note application 240 may store the note related information at the computing device 110, at a server computing device 120-2 associated with the note application 240, or a combination thereof.

In some embodiments, the note application 240 can include a filter that allows a user 105 to select between all available notes or notes for the specific website/application being utilized. Further, the note application 240 can provide a search capability such that notes can be searched and/or categorized by topic.

Additionally, the note application 240 can be launched independently of the web browser 302 or a specific application. In this manner, a user 105 can create a note and then link the note with a specific website or application for later reference.

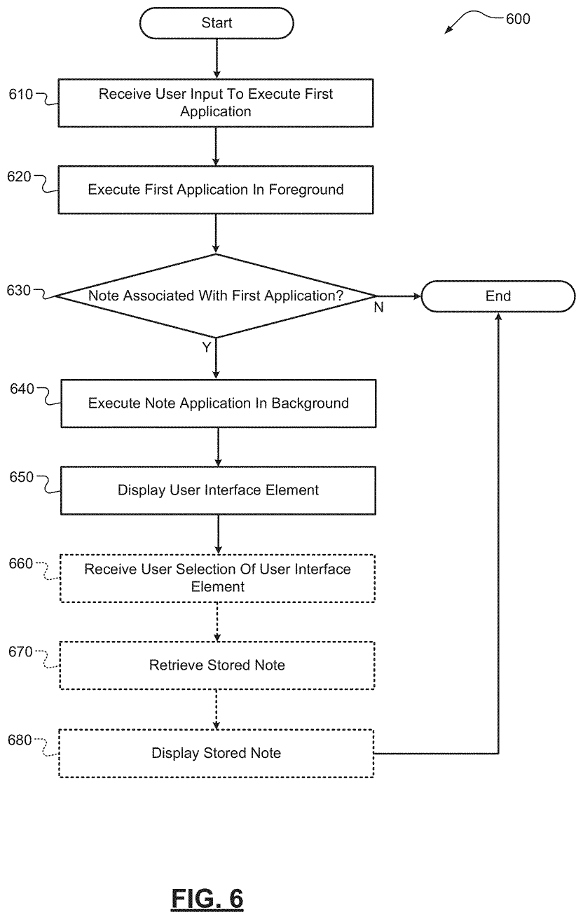

With further reference to FIG. 6, an example computer-implemented method 600 for creating and storing notes is disclosed. The method 600 can be performed by any computing device or devices, such as computing device 110, server computing devices 120-1, 120-2, and/or a combination thereof. For ease of description, the method 600 will be described hereinafter as being performed by a single computing device (computing device 110). It should be appreciated, however, that other devices may be utilized to perform some or all of the described method 600.

At 610, the method 600 can include receiving a user input from a user 105 to begin execution of a first application. The first application can be any computer application, including but not limited to a standalone application (e.g., for a banking service) and a web browser application for displaying webpages. In response to receiving the user input, the method 600 executes (620) the first application in a foreground of the computing device 110. It should be appreciated that executing in the “foreground” of the computing device 110 is intended to include executing the first application as the primary application of the computing device 110, including, e.g., displaying a user interface 300, 400, 500 of the first application through which the user 105 may interact with the application.

At 630, the computing device 110 can determine if the user 105 has associated (e.g., in the note application 240) a stored note with the first application based on the first application and the identity of the user 105. In implementations in which the first application is a web browser, determining if the user 105 has associated a stored note with the first application can further be based on the specific webpage being displayed by the web browser. When the user 105 has associated a stored note with the first application, the method 600 can proceed to execute (640) the note application 240 in the background of the computing device 110. It should be appreciated that executing in the “background” of the computing device 110 is intended to include executing an application as the secondary or otherwise non-primary application of the computing device 110, which typically includes displaying a user interface 300, 400, 500 of another application. At 650, the computing device 110 can display a user interface element such as a selectable button (e.g., the launch button 306) or hyperlink 406 described above in the user interface 300, 400, 500 of the first application, wherein the user interface element 306, 406 indicates a presence of the stored note associated with the first application.

In order to access the stored note, at 660, the user 105 can provide a user selection of the user interface element 306, 406 to the computing device 110. In response to receiving the user selection, the computing device 110 can retrieve (670) and display (680) the stored note (e.g., note 506). For example only, displaying the stored note 506 can include displaying the stored note 506 in the user interface 500 of the first application and/or displaying the stored note 506 in an overlay in the user interface 500 of the first application. Other manners of displaying the stored note 506 are contemplated.

A user 105 can create, update, edit, delete, or otherwise modify a stored note 506 in various manners. For example only, a user 105 can execute the note application 240 in the foreground of the computing device 110. The user 105 can then create a stored note 506 and or provide one or more edits to the stored note 506 to the computing device 110. The stored note 506 can then be updated to include the one or more edits.

In some implementations, application providers (including webpage providers) can offer registered users 150, after login, a link to the stored notes of the user 150, e.g., on a home page or as a tab on its navigation bar. A user 105 can have access to the note application 240 by paying an annual subscription personally or by being a registered user/customer of a company (or member of an organization) that pays for its users. For example only, the note application 240 can take the form of a web browser extension, which can permit use of the note application 240 with any webpage irrespective of its source. Furthermore, in the case of a cloud based storage of notes 506, the note application 240 can allow users 105 to access their notes from any computing device 110 (desktops, remote laptops and mobile cell phones) with which they are registered.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known procedures, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The term “and/or” includes any and all combinations of one or more of the associated listed items. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

As used herein, the term module may refer to, be part of, or include: an Application Specific Integrated Circuit (ASIC); an electronic circuit; a combinational logic circuit; a field programmable gate array (FPGA); a processor or a distributed network of processors (shared, dedicated, or grouped) and storage in networked clusters or datacenters that executes code or a process; other suitable components that provide the described functionality; or a combination of some or all of the above, such as in a system-on-chip. The term module may also include memory (shared, dedicated, or grouped) that stores code executed by the one or more processors.

Unless specifically stated otherwise as apparent from the above discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system memories or registers or other such information storage, transmission or display devices.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A computer-implemented method for creating and storing notes, comprising:
receiving, at a computing device having one or more processors, a user input from a user to begin execution of a first application;
in response to receiving the user input, executing, at the computing device, the first application in a foreground of the computing device, wherein executing the first application includes displaying a user interface of the first application;
determining, at the computing device, if the user has associated, in a note storage application, a stored note with the first application based on the first application and the user; and
when the user has associated the stored note with the first application in the note storage application:
executing, at the computing device, the note storage application in a background of the computing device, and
displaying, at the computing device, a user interface element in the user interface of the first application, wherein the user interface element indicates a presence of the stored note associated with the first application.

2. The computer-implemented method of claim 1, further comprising:
receiving, at the computing device, a user selection of the user interface element; and
in response to receiving the user selection:
retrieving, at the computing device, the stored note, and
displaying the stored note.

3. The computer-implemented method of claim 2, wherein displaying the stored note comprises displaying the stored note in the user interface of the first application.

4. The computer-implemented method of claim 2, wherein displaying the stored note comprises displaying the stored note in an overlay in the user interface of the first application.

5. The computer-implemented method of claim 2, further comprising:
receiving, at the computing device, one or more edits to the stored note from the user; and
updating the stored note to include the one or more edits.

6. The computer-implemented method of claim 1, wherein the first application is a web browser application, and wherein determining if the user has associated the stored note with the first application is further based on a webpage being displayed by the web browser.

7. The computer-implemented method of claim 6, wherein the user interface element comprises a hyperlink displayed by the web browser.

8. The computer-implemented method of claim 6, wherein the user interface element comprises a selectable button displayed by the web browser.

9. The computer-implemented method of claim 1, wherein the stored note is stored locally at the computing device.

10. The computer-implemented method of claim 1, wherein the stored note is stored remotely from the computing device.

11. A computing device, comprising:
one or more processors; and
a non-transitory computer-readable storage medium having a plurality of instructions stored thereon, which, when executed by the one or more processors, cause the one or more processors to perform operations comprising:
receiving a user input from a user to begin execution of a first application;
in response to receiving the user input, executing the first application in a foreground of the computing device, wherein executing the first application includes displaying a user interface of the first application;
determining if the user has associated, in a note storage application, a stored note with the first application based on the first application and the user; and
when the user has associated the stored note with the first application in the second application:
executing the note storage application in a background of the computing device, and
displaying a user interface element in the user interface of the first application, wherein the user interface element indicates a presence of the stored note associated with the first application.

12. The computing device of claim 11, wherein the operations further comprise:
receiving a user selection of the user interface element; and
in response to receiving the user selection:
retrieving the stored note, and
displaying the stored note.

13. The computing device of claim 12, wherein displaying the stored note comprises displaying the stored note in the user interface of the first application.

14. The computing device of claim 12, wherein displaying the stored note comprises displaying the stored note in an overlay in the user interface of the first application.

15. The computing device of claim 12, wherein the operations further comprise:
receiving, at the computing device, one or more edits to the stored note from the user; and
updating the stored note to include the one or more edits.

16. The computing device of claim 11, wherein the first application is a web browser application, and wherein determining if the user has associated the stored note with the first application is further based on a webpage being displayed by the web browser.

17. The computing device of claim 16, wherein the user interface element comprises a hyperlink displayed by the web browser.

18. The computing device of claim 16, wherein the user interface element comprises a selectable button displayed by the web browser.

19. The computing device of claim 11, wherein the stored note is stored locally at the computing device.

20. The computing device of claim 11, wherein the stored note is stored remotely from the computing device.
